(19) United States
(12) Patent Application Publication
(10) Pub. No.: US 2020/0038277 A1
(43) Pub. Date: Feb. 6, 2020

(54) Multi-Function Exercise Machine

(71) Applicant: Hui-Ling Chang, Changhua County (TW)

(72) Inventor: Hui-Ling Chang, Changhua County (TW)

(21) Appl. No.: 16/529,802

(22) Filed: Aug. 2, 2019

(30) Foreign Application Priority Data
Aug. 3, 2018 (TW) 107210653

(51) Int. Cl. A61H 1/00; A61H 23/02; A63B 21/00; A63B 23/04

(52) U.S. Cl. CPC A61H 1/005; A61H 23/0263; A61H 2001/0203; A63B 23/0458; A63B 21/00178; A63B 21/4033

(57) ABSTRACT

A multi-function exercise machine includes a vibration machine which includes a base and a step seat. The base is provided with a driving device connected to a loading base which is able to swing and vibrate repeatedly. The top of the loading base is connected to the step seat while a rotating disc is arranged at the step seat. An adjustment part is pivotally disposed on each of two sides of the base and rotatable thereon. After being turned, the adjustment abuts against the base so that the loading base is fixed, unable to be wobbled. The rotating disc is pivotally disposed on the middle part of the step seat and able to be turned on the step seat.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an exercise machine, and more particular to a multi-function exercise machine that provides various exercise patterns including aerobic stepping, vibrating massage and waist twisting. A driving device provided with a driving motor is used. An eccentric block is arranged at a rotor of the driving motor. Thereby, the rotor drives the eccentric block to rotate coaxially and synchronously to generate a centrifugal force. Then, the centrifugal force is transmitted to a loading base to produce vibrations for the loading base. Thus, users can step on a step seat for exercising passively. Moreover, an adjustment part is used to fix the loading base so that users can step up and down for aerobic exercise.

### Description of Related Arts

As revealed in Taiwanese Pat. No. 1300719, a conventional vibration machine includes a driving member disposed on a base. The driving member is provided with a rod portion which is connected to a bottom of a loading seat for pushing the loading seat to move pivotally and further driving a top seat to swing vertically, forward and backward, and side to side. Thus, users can do exercise passively while stepping or sitting on the vibration machine.

Moreover, a conventional fitness and exercise platform consists of a rectangular plate allowing users to step on and a base disposed under the plate and set on the ground directly. Through stepping on the upper and the lower plates, users can do exercise like walking up and down the stairs. In combination with the technique of positioning central line of the body, users can also get into shape.

However, either the fitness and exercise platform or the vibration machine provides only a single pattern of doing exercise. Users are easy to get bored while doing exercise. Thus, there is a room for improvement and there is a need to provide a novel versatile exercise machine.

### SUMMARY OF THE PRESENT INVENTION

Therefore, it is a primary object of the present invention to provide a multi-function exercise machine which offers users both passive exercise and active exercise patterns so that users can do various exercises by using a single machine.

In order to achieve the above object, a multi-function exercise machine according to the present invention is able to be used as a vibration machine formed by a base and a step seat. The base is formed by a frame with a mounting space therein and a driving device is mounted in the mounting space. The driving device consists of a driving motor and a rotor connected with an eccentric block. An axis of the driving motor is passed through the frame and then pivotally disposed on a connection portion. A loading base is connected to and fixed on the connection portion. The top of the loading base is connected to the step seat while a rotating disc is arranged at the step seat. Once the driving motor starts working, the rotor drives the eccentric block to rotate coaxially and synchronously to generate a centrifugal force. Then, the centrifugal force is transmitted to a rotating shaft of the driving motor so that the connection portion is synchronously driven to swing and make the loading base having vibrations. At the same time, the step seat is driven by the loading base to be vibrated. Thereby, users can step on the step seat to have vibrations passively.

An adjustment part is pivotally disposed on each of two sides of the frame and rotatable on the frame. After being turned, the adjustment part abuts against the loading base so that the loading base is fixed and unable to swing. Thereby, the multi-function exercise machine is used as a step board for users to do aerobic stepping.

The rotating disc is pivotally disposed on the step seat and able to be turned thereon. Thus, users can move and twist their waist for exercise once stepping on the disc.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a top exploded view of a preferred embodiment according to the present invention.

FIG. 2 is a bottom exploded view of the above preferred embodiment according to the present invention.

FIG. 3 is a sectional view showing an assembly of a base and a loading base of the above preferred embodiment according to the present invention.

FIG. 4 is a front view of a base assembled with a loading base and an adjustment part abutting against the loading base of the above preferred embodiment according to the present invention.

FIG. 5 is a schematic drawing showing a front view of a base assembled with a loading base of the above preferred embodiment during vibration according to the present invention.

FIG. 6 is a side view of a base assembled with a loading base and an adjustment part abutting against the loading base of the above preferred embodiment according to the present invention.

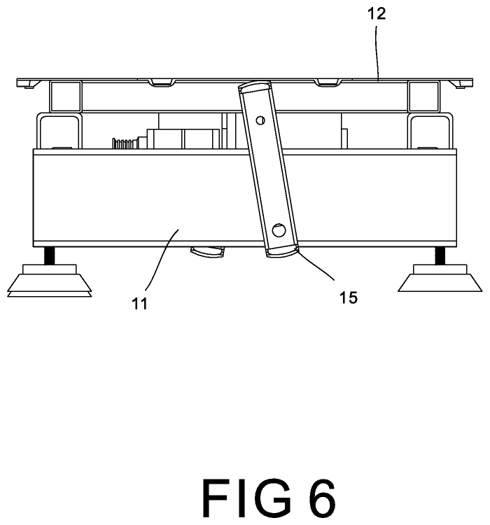

FIG. 7 is a side view of a base assembled with a loading base and an adjustment part away from the loading base of the above preferred embodiment according to the present invention.

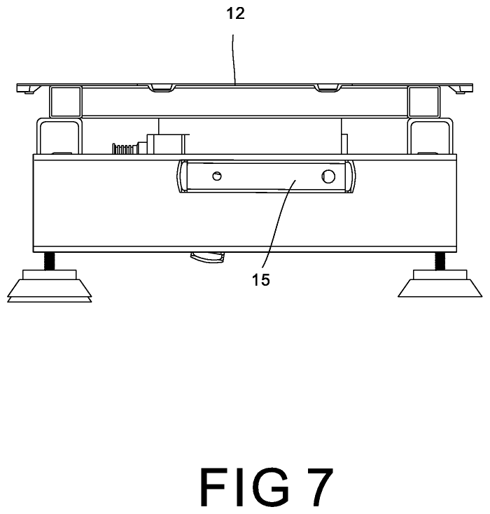

FIG. 8 is a perspective view showing another preferred embodiment with a rotating disc according to the present invention.

FIG. 9 is a schematic drawing showing the embodiment as shown in FIG. 8 in which the rotating disc is locked and unable to be rotated according to the present invention.

FIG. 10 is a schematic drawing showing the embodiment as shown in FIG. 8 in which the rotating disc is unlocked and able to be rotated according to the present invention.

### DETAILED DESCRIPTION OF THE PREFERRED EMBODIMENT

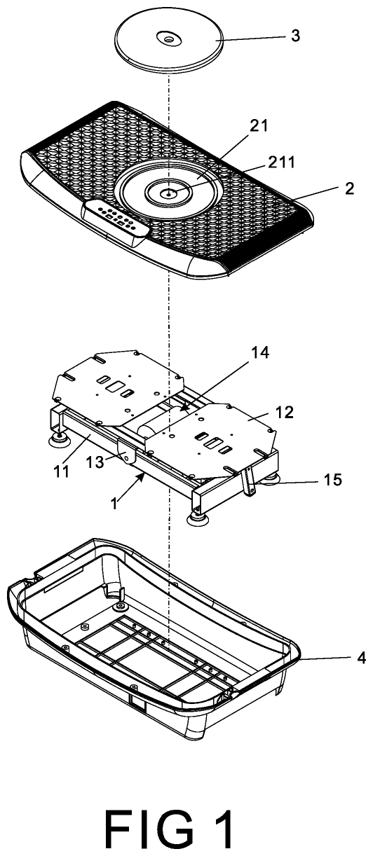

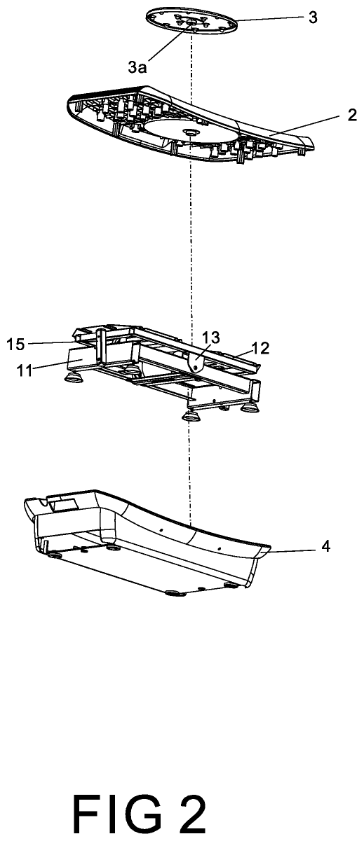

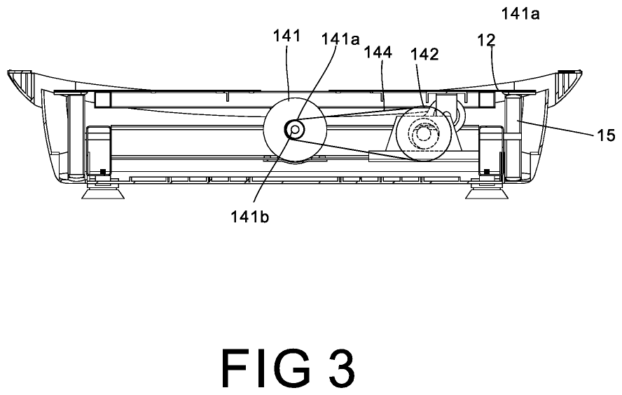

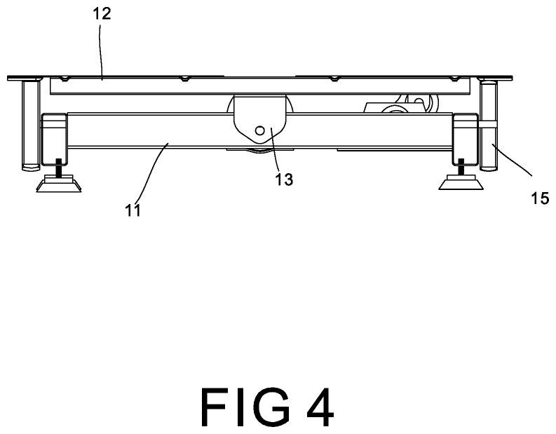

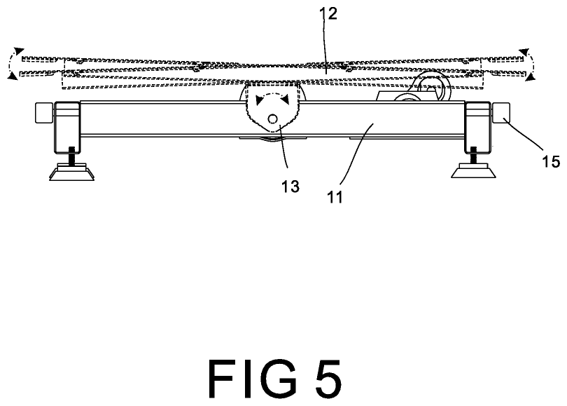

Referring to FIG. 1, FIG. 2, FIG. 3 and FIG. 4, a vibration machine according to a preferred embodiment of the present invention is revealed. The vibration machine includes a base 1, a step seat 2, a rotating disc 3, and a protection case 4. The base 1 comprises a frame 11 having a mounting space therein and a driving device 14 mounted in the mounting space of the frame 11. The base 1 is mounted in the protection case 4. As shown in FIG. 3, the driving device 14 includes a driving motor 141, a rotor 143 and a circular belt 144. The rotor 143 which is provided with an eccentric block is arranged at one side of the driving motor 141. One end of the circular belt 144 is wound around a part of a rotating shaft 141a of the driving motor 141 while the other end of the circular belt 144 is fit on the rotor 143. An axis 141b of the rotating shaft 141a is first passed through and pivotally disposed on one side of the frame 11 of the base 1 and then to be connected to and fixed by a connection portion 13. The connection portion 13 can be pivotally rotated on the frame 11. A loading base 12 is fixed on top of the connection portion 13 and able to be vibrated within a certain distance owing to the connection therebetween. That means the loading base 12 is unstable and wobbly. The top of the loading base 12 is connected to the step seat 2. The step seat 2 is has a circular groove 21 and a pivot hole 211 arranged at a center of the circular groove 21. A fitting portion 3a is extended from a bottom of the rotating disc 3 and is pivotally mounted into the pivot hole 211. Thereby, the rotating disc 3 is able to be rotated within the circular groove 21 of the step seat 2. An adjustment part 15 is pivotally disposed on each of two sides of the frame 11 and rotatable on the frame 11. After the driving motor 141 starting running, the rotating shaft 141a drives the circular belt 144 so that the circular belt 144 further drives the rotor 143. Then the eccentric block rotates coaxially and synchronously to generate a centrifugal force that is transmitted to the rotating shaft 141a. Thus, the rotating shaft 141a turns repeatedly and the connection portion 13 wobbles at the same time. Therefore, the loading base 12 further swings to produce vibrations, as shown in FIG. 5. The step seat 2 is also driven by the loading base 12 to be vibrated. Thereby users are provided with a passive vibration pattern while stepping on the step seat 2.

After being rotated, the adjustment part 15 abuts against the loading base 12 so that each of two sides of the loading base 12 is fixed owing to the adjustment part 15 and unable to swing. Now, the device is used as a step board for users to do aerobic stepping. The loading base 12 turns back to the unstable state, able to be vibrated, when the adjustment part 15 is moved away from the loading base 12.

The disc 3 is pivotally arranged at the step seat 2 and able to be rotated on the step seat 2. Thus, users can move and twist their waist once stepping on the disc 3.

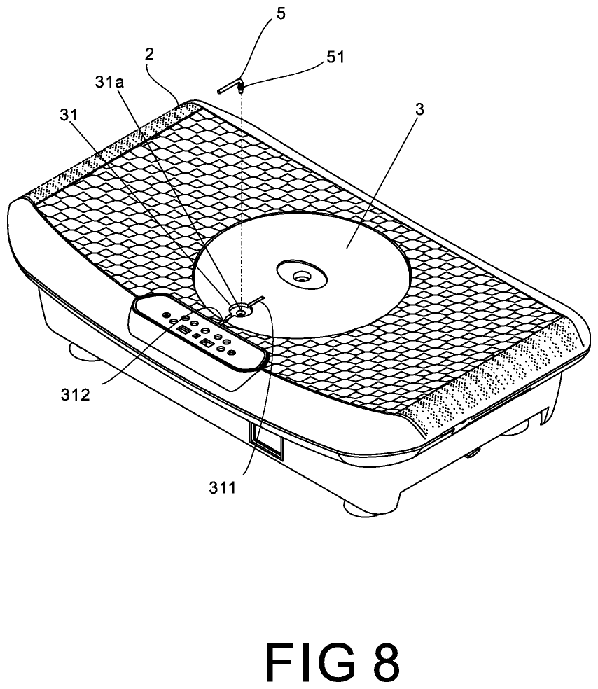

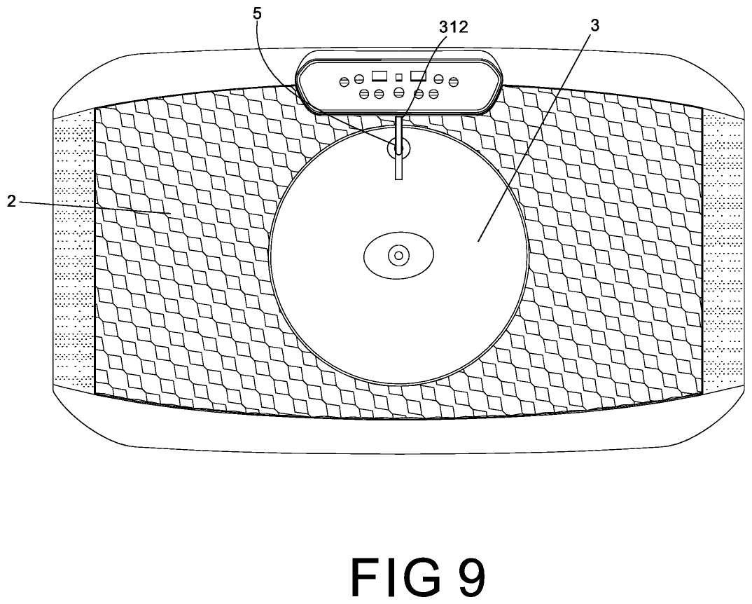

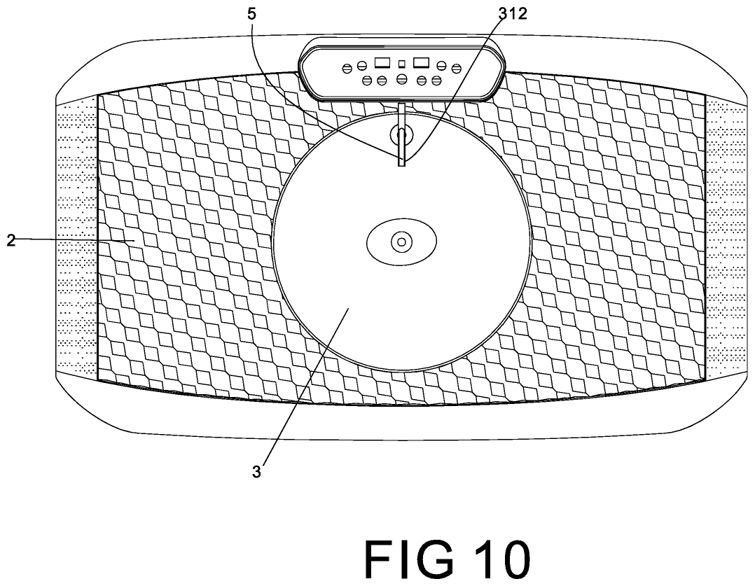

Referring to FIG. 8, FIG. 9 and FIG. 10, another preferred embodiment is disclosed. A positioning slot 31 is disposed on the disc 3 at the position close to the circumference of the disc 3 and an assembly hole 31a is provided at a center of the positioning slot 31. Two ends of the positioning slot 31 are extending to form a first mounting portion 311 and a second mounting portion 312, respectively. The first mounting portion 311 and the second mounting portion 312 are opposite and corresponding to each other. The second mounting portion 312 is extended to the step seat 2, outside the disc 3. A locking member 5 is an L-shaped stick formed by a bending long rod. The locking member 5 includes a shorter body and a longer body. A spring 51 is disposed around the shorter body and then the shorter body with the spring 51 therearound is mounted into the assembly hole 31a. By means of the spring 51, the locking member 5 has a floating elasticity, capable of being moved vertically within the limited distance and pivotally rotated within the assembly hole 31a. The longer body of the locking member 5 is able to be mounted into the first mounting portion 311 or the second mounting portion 312. As shown in FIG. 9 and FIG. 10, the disc 3 is locked (unable to be turned) when the longer body of the locking member 5 is turned and mounted into the second mounting portion 312. Yet the disc 3 is unlocked and able to be turned again when the longer body of the locking member 5 is moved to and mounted into the first mounting portion 311.

Moreover, the positioning slot 31 can also be arranged at the center of the disc 3 and the locking member 5 can be pivotally connected to the positioning slot 31 at the center of the disc 3.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A multi-function exercise machine, comprising:
a base which includes
a frame with a mounting space therein,
a driving device, mounted in the mounting space, comprising
a driving motor provided with an axis passed through one side of the frame, and
a rotor connected with an eccentric block;
a connection portion pivotally connected to the axis of the driving motor;
a loading base fixed on the connection portion;
a step seat disposed over and covering the loading base; and
a rotating disc which is pivotally arranged at the step seat and able to be rotated on the step seat for waist twisting while stepping on thereon;
wherein the rotor drives the eccentric block to rotate coaxially and synchronously to generate a centrifugal force once the driving motor starts working and then the centrifugal force is transmitted to a rotating shaft of the driving motor, wherein the connection portion is synchronously driven to swing and make the loading base having vibrations, wherein the step seat is driven by the loading base to be vibrated at the same time so as to provide a passive vibration pattern while stepping on the step seat, wherein an adjustment part is pivotally disposed on each of two sides of the frame and rotatable on the frame for leaning against the loading base, thereby the loading base is fixed without wobbling and the multi-function exercise machine is used as a step board for aerobic stepping, wherein the loading base turns back to the vibration pattern once the adjustment part is rotated and away from the loading base.

2. The multi-function exercise machine as claimed in claim 1, wherein the step seat has a circular groove and a pivot hole provided at a center of the circular groove, wherein a fitting portion is extended from a bottom of the rotating disc and is pivotally mounted into the pivot hole, thus the rotating disc is able to be turned within the circular groove of the step seat.

3. The multi-function exercise machine as claimed in claim 1, wherein the base is mounted in a protection case.

4. The multi-function exercise machine as claimed in claim 1, wherein a positioning slot is disposed on the disc at the position close to the circumference of the disc and an assembly hole is provided at a center of the positioning slot, wherein two ends of the positioning slot are extending to form a first mounting portion and a second mounting portion respectively, wherein the first mounting portion and the second mounting portion are opposite and corresponding to each other, wherein the second mounting portion is extended to the step seat, outside the disc, wherein a locking member is a L-shaped stick formed by a shorter body and a longer body, wherein a spring is disposed around the shorter body and then the shorter body with the spring therearound is mounted into the assembly hole, thereby the locking member is having a floating elasticity and able to be moved vertically within the limited distance owing to the spring.

5. The multi-function exercise machine as claimed in claim 1, wherein the positioning slot is able to be formed at the center of the disc and the locking member is pivotally disposed on the positioning slot at the center of the disc.
